(19) United States
(12) Patent Application Publication
(10) Pub. No.: US 2015/0075040 A1
(43) Pub. Date: Mar. 19, 2015

(54) DISPLAY ITEM SLIDE

(71) Applicant: PRESS ENGINEERING (PTY) LTD., Johannesburg (ZA)

(72) Inventor: Shaun Leroy Blumberg, Johannesburg (ZA)

(73) Assignee: PRESS ENGINEERING (PTY) LTD., Johannesburg (ZA)

(21) Appl. No.: 14/485,877

(22) Filed: Sep. 15, 2014

(30) Foreign Application Priority Data
Sep. 16, 2013 (ZA) 2013/06960

(51) Int. Cl. G09D 3/04; B21D 22/00; B23D 15/08; B21D 53/00; B21D 43/09

(52) U.S. Cl. CPC G09D 3/04; B21D 53/00; B21D 43/09; B23D 15/08; B21D 22/00
USPC 40/109; 72/339

(57) ABSTRACT

Equipment for manufacturing a display item slide having a predetermined length is provided. The equipment includes a first feed arrangement for feeding sheet material, in use, from a roll thereof that has a width substantially equal to the length of the display item slide, a parting means for parting a narrow strip of material from a free end of the roll, and a forming arrangement for forming the strip to a predetermined profile. Further according to the invention there is provided a method of manufacturing a display item slide having a predetermined length, which includes providing a roll of sheet material that has a width substantially equal to the length of the display item slide, parting a narrow strip of material from a free end of the roll, and forming the strip to a predetermined profile. Still further the invention extends to a display item slide which has been manufactured by means of the equipment of the invention or in accordance with the method of the invention.

THIS INVENTION relates to a display item slide for display items, in particular slides for single sheet calendars. It further relates to equipment for manufacturing display item slides, a method of manufacturing display item slides and a display item slide manufactured using the equipment or by means of the method.

According to the invention there is provided equipment for manufacturing a display item slide having a predetermined length, which includes
a first feed arrangement for feeding sheet material, in use, from a roll thereof that has a width substantially equal to the length of the display item slide;
a parting means for parting a narrow strip of material from a free end of the roll; and
a forming arrangement for forming the strip to a predetermined profile.

Further according to the invention there is provided a method of manufacturing a display item slide having a predetermined length, which includes
providing a roll of sheet material that has a width substantially equal to the length of the display item slide;
parting a narrow strip of material from a free end of the roll; and
forming the strip to a predetermined profile.

Still further the invention extends to a display item slide which has been manufactured by means of the equipment of the invention or in accordance with the method of the invention.

The display item slide may have a hanger. Thus the equipment may include a second feed arrangement for feeding a ribbon of hanger feedstock from a supply thereof, a shaping means for shaping a hanger from the said ribbon and an attaching arrangement for attaching the hanger to an intermediate formed display item slide blank.

The hanger may be attached to the blank by means of a staking or riveting operation.

It will be appreciated by those skilled in the art that the blank is formed from a narrow strip that has a longitudinal axis. Thus the display item slide may be formed to have a longitudinal channel with a first end and second end and a longitudinal bend extending from the first end to the second end. Thus, it may have a first bend portion and a second bend portion joined by the longitudinal bend, the first and second bend portions each having respective interior confronting surfaces adapted to receive an edge of the display item therebetween and respective exterior surfaces. The second bend portion may be wider than the first bend portion such that an end profile of slide is generally J-shaped The hanger may be generally centrally fast with the second bend portion and may be secured to the interior surface of the second bend portion.

A pair of bulges may also be formed that project from the first bend portion. They may preferably project from the exterior surface of the first bend portion.

The slides may be of metal, in particular mild steel, and the exterior surfaces of the first and second bend portions may be coated.

The parting means may conveniently be a guillotine.

The forming arrangement may operate in a press forming manner and may comprise a former and an anvil. The strip may be formed to have the profile described above in a single operation.

Preferably the forming arrangement may be transversely downstream of the parting means, such that a strip of material resulting from the parting operation is displaced transversely from the parting means to the forming arrangement.

Similarly, the attaching arrangement for attaching the hanger to the blank provided, in use, by the forming arrangement may also be transversely downstream of the forming arrangement, such that the blank is displaced transversely from the forming arrangement to the attaching arrangement.

In addition, the hanger feed arrangement and shaping means may be located transversely of the attaching arrangement, on the other side thereof to the forming arrangement.

The invention will now be described in more detail by way of example only with reference to the accompanying drawings.

In the drawings:

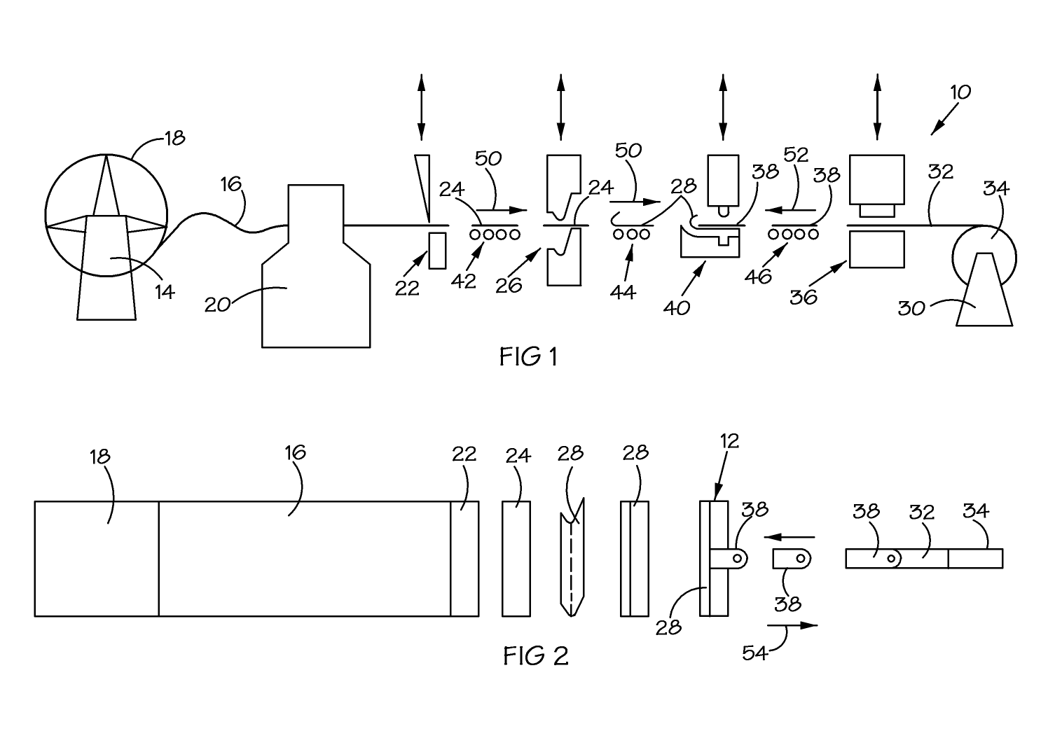

FIG. 1 shows a schematic side view of equipment for manufacturing display item slides in accordance with the invention;

FIG. 2 shows schematically, in plan view, various stages in the method of manufacturing the display item slides;

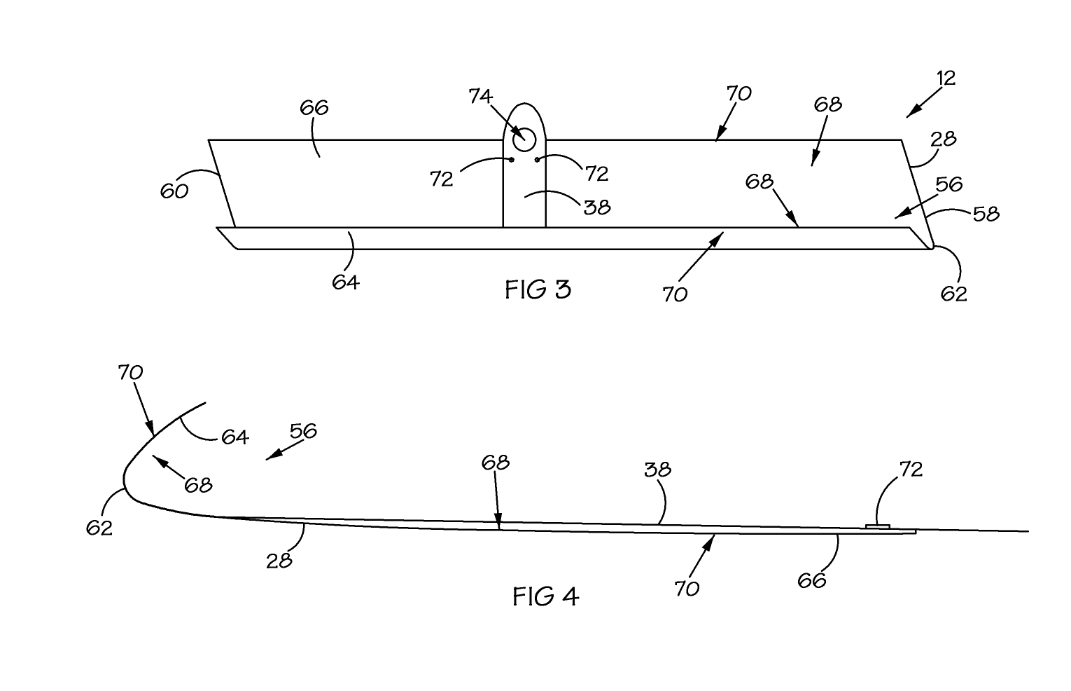

FIG. 3 shows a perspective view of a display item slide manufactured with the equipment and in accordance with the method of the invention; and

FIG. 4 shows schematically, on an enlarged scale, a side view profile of the display item slide.

Referring to FIG. 1, reference numeral 10 generally indicates an embodiment of equipment, in accordance with the invention, for manufacturing display item slides, one of which is shown in FIG. 3 by reference numeral 12. As indicated above, the display item slide may particularly be used to provide a rim for single sheet calendars, such that the slides are also referred to as calendar rims.

Thus, as shown in FIG. 1, the equipment 10 includes a first feed arrangement 14 for feeding sheet material 16 from a roll 18, a straightening unit 20, a parting means in the form of a guillotine 22 for cutting off narrow end portions from a free end of the sheet material 16 to provide narrow strips 24, a forming arrangement comprising a press 26 for forming the strips 24 to provide blanks 28, being the formed strips 24, which have a predetermined profile (as discussed hereinbelow), a second feed arrangement 30 for feeding a narrow ribbon 32 of plastic hanger material from a roll 34 thereof, a shaping means in the form of a punch 36 for punching hangers 38 from the ribbon 32 and an attaching arrangement comprising a staking unit 40 for staking the hangers 38 to the blanks 28. The equipment also has displacing devices 42, 44 and 46 for displacing the strips 24, the blanks 28 and the hangers 38, respectively.

It is to be noted that the roll 18 has a width that is equal to the length of the desired display item slide. Thus, the roll 18 has a width of between 175 mm and 760 mm in accordance with the length of the desired display item slide to be manufactured. It will thus be appreciated by those skilled in the art that the equipment 10 is designed for the longest display item slide that is intended to be manufactured and also to accommodate rolls that have a smaller width to be able also to manufacture display item slides that are shorter. It will also be appreciated by those skilled in the art that wastage is, accordingly, significantly reduced.

Conventionally the sheet material 16 will be of black plate or tin plate mild steel and will have a thickness of between 0.19 mm and 0.21 mm.

The guillotine 22 will, conventionally, be set to provide strips 24 with a width of between 17 mm and 19 mm.

It will be appreciated that the strips 24 and blanks 28 have a longitudinal axis, as do the guillotine 22, press 26 and staking unit 40, and that the displacing units 42 and 44 move them transversely from the guillotine 22 to the press 26 and from the press 26 to the staking unit 40, as indicated by arrows 50. Further, the displacing unit 46 moves the hangers 38 to the staking unit 40 from an opposite side to the displacing unit 44, in a direction 52 that is longitudinal with respect to the hangers 38 themselves, but also transversely with respect to the staking unit 40. It will also be appreciated that the manufactured display item slides 12 are also removed transversally, in the same direction at which the blank 28 was fed, underneath the hanger forming station, as indicated by arrow 54.

Referring now to FIGS. 3 and 4, it will be seen that the blank 28 has a longitudinal channel 56 with a first end 58 and second end 60 and a longitudinal bend 62 extending from the first end 58 to the second end 60. Thus, it has a first bend portion 64 and a second bend portion 66 joined by the longitudinal bend 62. The first and second bend portions 64, 66 each have respective interior confronting surfaces 68 adapted to receive, in use, an edge of a display item (not shown) therebetween and respective exterior surfaces 70. The second bend portion 66 may be wider than the first bend portion 64 such that an end profile of the blank 28 is generally J-shaped The hanger 38 is generally centrally fast with the second bend portion 66 and is secured to the interior surface 68 of the second bend portion 66 by rivets 72 formed from the material of the second bend portion 66 by the staking unit 40. Further as shown in FIG. 3, the hangers 38 have holes 74.

It will also be appreciated by those skilled in the art that single sheets of paper or the like are very often bound at both ends. Thus, at an upper end of the sheet a display item slide 12 with a hanger 38 is used and, at the bottom end a display item slide without a hanger 38, which is the blank 28. Thus, this specification must be understood to mean that the blanks 28 also constitute display item slides in accordance with the invention.

Still further, those skilled in the art will understand that the shaping of the hanger and the staking thereof to the blank could be performed in one operation at a single station, and that the parting of the strip and the forming thereof to be a blank may also be performed at the same station, in a single operation or in separate operations.

1. Equipment for manufacturing a display item slide having a predetermined length, which includes
a first feed arrangement for feeding sheet material, in use, from a roll thereof that has a width substantially equal to the length of the display item slide;
a parting means for parting a narrow strip of material from a free end of the roll; and
a forming arrangement for forming the strip to a predetermined profile.

2. Equipment according to claim 1, which includes a second feed arrangement for feeding a ribbon of hanger feedstock from a supply thereof, a shaping means for shaping a hanger from the said ribbon and an attaching arrangement for attaching the hanger to a formed strip.

3. Equipment according to claim 1, wherein the parting means comprises a guillotine.

4. Equipment according to claim 1, wherein the forming arrangement is operable in a press forming manner and comprises a former and an anvil arranged to form, in use, the predetermined profile in a single operation.

5. Equipment according to claim 1, wherein the forming arrangement is located transversely downstream of the parting means, such that a strip of material resulting from the parting operation is displaced, in use, transversely from the parting means to the forming arrangement.

6. Equipment according to claim 2, wherein the attaching arrangement is located transversely downstream of the forming arrangement, such that the formed strip is displaced, in use, transversely from the forming arrangement to the attaching arrangement.

7. Equipment according to claim 2, wherein the second feed arrangement and shaping means are located transversely of the attaching arrangement, on the other side thereof to the forming arrangement.

8. A method of manufacturing a display item slide having a predetermined length, which includes:
providing a roll of sheet material that has a width substantially equal to the length of the display item slide;
parting a narrow strip of material from a free end of the roll; and
forming the strip to a predetermined profile.

9. The method of claim 8, which includes:
providing a supply of hanger feedstock ,
shaping a hanger from the feedstock; and
attaching the hanger to a formed strip.

10. A display item slide which has been manufactured in accordance with the equipment claimed in any one of claims 1 to 8.

11. A display item slide which has been manufactured in accordance with the method as claimed in claim 9 or 10.
